(19) United States
(12) Patent Application Publication
(10) Pub. No.: US 2014/0208984 A1
(43) Pub. Date: Jul. 31, 2014

(54) NON-SHEET FORM STRUCTURAL BUILDING ELEMENT CONTAINING GLASS CULLET & PROCESS FOR MAKING SAME

(71) Applicant: DAY & CAMPBELL LIMITED, Hamilton (CA)

(72) Inventor: Justin Campbell, Ancaster (CA)

(21) Appl. No.: 14/101,619

(22) Filed: Dec. 10, 2013

(30) Foreign Application Priority Data
Jan. 25, 2013 (CA) 2804590

(51) Int. Cl. C04B 18/04

(52) U.S. Cl. CPC C04B 18/04
USPC 106/716; 264/333

(57) ABSTRACT

A process for the production of a non-sheet form structural building element incorporating glass cullet, preferably from consumer waste glass streams, which glass cullet has a particle size distribution of −½″+12 mesh in an amount from 1% to 50% by weight and imparts an appearance simulating natural quarried stone, or terrazzo, and the non-sheet form structural building element made from this process. The composition of the building element also includes Portland cement, and one or more of concrete sand, stone aggregate, blast furnace slag and one or more of silica fume, silica sand and silica flour. The method includes a two-step curing process which involves curing a preform formed by molding of the concrete mixture without the addition of heat or steam for a first curing period, followed by curing of the preform in an autoclave, at temperatures ranging from 250 to 366° F. and at pressures ranging from 100 to 150 p.s.i. for a second curing period. The building element thus formed is highly resistant to degradation caused by the alkali-silica reaction, and exhibits high compressive strengths as compared to known concrete products incorporating glass cullet.

### FIELD OF THE INVENTION

The present invention relates generally to the field of concrete compositions incorporating a significant portion of crushed glass cullet, which glass cullet may, particularly where larger sizes of glass fragments are used, impart an appearance simulating natural quarried stone, or terrazzo, and more particularly to structural building elements made from these compositions, and to a method of manufacturing same.

### BACKGROUND OF THE INVENTION

For many years, industry has sought effective methods for introducing waste glass into concrete building products as an effective way to divert such glass from landfill sites. Typically, these efforts to produce so-called “green” or “eco-friendly” cement products involve substituting waste glass for a portion of the Portland cement, concrete sand, or aggregates otherwise used in conventional concrete mixtures. However, it has proven to be difficult to effectively introduce waste glass into concrete mixtures, as concrete typically undergoes an undesirable chemical reaction with the glass, which reaction contributes to degradation of the glass/concrete thus produced. This chemical reaction is termed “the alkali-silica reaction” (hereinafter, “ASR”), and results from a reaction between concrete, which is alkaline, and glass, which contains a high proportion of silica. Alkalis from the concrete and silica from the glass combine over time to form a gel that expands in the presence of moisture to result in cracking of the cured concrete. While ASR may also result from a reaction between the concrete and the silica naturally occurring in the aggregate portion of the concrete mixture, the addition of waste glass, particularly in larger particle sizes, exacerbates the problem, as the waste glass added has itself a very high silica content. If unchecked, the ASR can, particularly over longer periods of time, cause serious expansion, spalling and cracking of cured concrete mixtures. This is particularly troublesome where the concrete mixture experiencing ASR is structural (i.e., loadbearing), and can, in extreme cases, result in the need to demolish a particular structure.

The problem of ASR in cement/glass mixtures has been mitigated to some extent in the prior art by the following approaches.

The prior art teaches that the use of larger glass fragments, such as glass cullet from waste glass streams, as a component in concrete is undesirable, as such use promotes the ASR reaction occurring over time between the silica present in the glass and the alkalis present in the other components of the concrete. See, for example U.S. Pat. No. 7,413,602 (Grasso, Jr. et al.) at column 1, lines 48-52). It is known, however that if the crushed glass is ground into a fine powder (i.e., having an average particle sizes of less than about 0.15 mm), it behaves as a pozzolanic material that can be partially substituted for Portland cement in concrete mixtures, thereby exhibiting a cementing property when moistened. In this manner, it is thought that the powdered glass functions as siliceous materials to neutralize the excessive alkalinity of the cement with silicic acid, by voluntarily provoking a controlled pozzolanic reaction at the early stages of the cement curing. It is thought that the finely ground glass powder reacts preferentially with the cement alkalis, without the formation of an expansive pressure, because siliceous minerals in fine particle form convert to alkali silicate, and then to calcium silicate, without formation of semipermeable reaction rims. In this manner, the silica form the ground glass is chemically bonded with the alkalis present in the aggregate and other components of the concrete mixture during curing, thus minimizing their subsequent availability for reaction as part of the destructive ASR process. Patents teaching the use of finely ground glass powders to combat ASR include: U.S. Pat. No. 5,803,960 (Baxter); U.S. Pat. No. 5,810,921 (Baxter et al.); U.S. Pat. No. 6,296,699 (Jin), and U.S. Pat. No. 7,413,602 (Grasso, Jr. et al.).

A common variant of this prior art approach to controlling ASR involves the addition of various other additives in controlled amounts to the concrete mixture in addition to the finely ground glass particles to hasten the beneficial early binding of the silicates. These additives include alkali metal salts, chromium salts and metakaolin. Patents teaching this approach include the following: U.S. Pat. No. 5,803,960 (Baxter); U.S. Pat. No. 5,810,921 (Baxter et al.); and U.S. Pat. No. 7,700,017 (McCarthy et al.).

A further variant to this latter approach is to restrict the glass used in the cement mixture to that having specific chemical properties, such as, for example, finely ground chromium containing glass, as taught by, for example, U.S. Pat. No. 5,810,921 (Baxter et al.); finely ground lithium containing glass, free of zirconium, as taught by, for example: U.S. Pat. No. 5,803,960 (Baxter); or finely ground lithium containing glass, free of sodium ions, as taught by U.S. Pat. No. 6,500,254 (Baxter et al.), thereby reducing the need for using additives, as mentioned above.

All of the prior art approaches discussed above are less than satisfactory from the standpoints of practicality and cost. More particularly, the use of the indicated additives adds to the cost of cement mixtures which incorporate them. Moreover, such additives may not always be readily available. Also, those prior art methods which rely on the pre-selection of specific types of glass as starting materials to be included in the concrete mixture are difficult and costly to implement and to practice, and are subject to failure if the selected glass is not closely monitored. Whole batches of cement products may be rendered sub-standard by the inclusion of relatively minor amounts of the incorrect type of glass. As such, these prior art methods are not particularly suited for being supplied with waste glass from high-volume post-consumer waste handling streams, where such pre-selection may not be practical or economical on a sustainable large-scale basis. Additionally, the extra cost associated with finely grinding waste glass (typically by pulverizing and ball milling) to the small average particle sizes required by the prior art (typically less than about 0.15 mm) further adds to the cost of the concrete products produced by such methods.

While the prior art methodologies discussed above show some efficacy in mitigating the deleterious effects of ASR in glass/concrete mixtures through the mechanism of grinding the waste glass portion into a fine powder (with or without the use of other additives), they fail to address or provide a solution to the problem of effectively mitigating against the harmful effects of ASR in relation to concrete building products incorporating significant amounts of relatively larger sized fragments of waste glass (i.e., having particle sizes greater than about 0.15 mm, and preferably greater than about 0.5 mm), where these larger sized fragments of glass are distributed substantially consistently throughout the volume of the concrete product and where such larger sized glass fragments may be visible on one or more exposed surfaces of the finished concrete product, thereby to simulate terrazzo or quarried natural stone elements, such as, by way of non-limiting example, granite, quartz, marble and the like. Such larger sized glass fragments are referred to throughout this specification and the appended claims as “glass cullet”, and sustainable commercial supplies of same from waste glass have become readily available in recent years.

Accordingly, there remains in the prior art a continued need to solve the problem of ASR degradation in relation to green, eco-friendly concrete products incorporating significant amounts of glass cullet, without the need to first finely grind the glass cullet, or to require the use of special additives for repression of ASR.

There further remains a continued need to solve the problem of ASR degradation in relation to green, eco-friendly concrete products incorporating significant amounts of glass cullet from waste glass streams, without the need to carefully pre-select the type of waste glass to be used therein.

Moreover, the prior art problems discussed herein are particularly acute in relation to concrete products incorporating significant amounts of glass cullet, where the fragments of such glass cullet are larger than about 0.15 mm and are dispersed substantially consistently throughout the volume of the concrete product and are visible on one or more exposed surfaces of the finished concrete product so as to simulate terrazzo or quarried natural stone.

The shortcomings of the prior art are particularly problematic in relation to pre-cast concrete products requiring sufficient strength and longevity to allow for their use as structural building components, such as, for example, pre-cast concrete blocks, posts, beams and lintels. Prior art attempts to construct structural pre-cast concrete building elements containing significant amounts of larger sized glass fragments have lacked sufficient compressive strength to meet modern building code requirements for such elements.

The present invention solves or ameliorates one or more of the problems described above in relation to the prior art by providing a concrete structural building element and process for producing same that allows for the incorporation of significant amounts of glass cullet, particularly waste glass cullet, into the concrete mixture used to form the product, without the need for special ADR suppressant additives, without the need for careful pre-selection of the types of glass used within the process, and without the need to restrict the glass component used therein to finely crushed particles or powdered form.

### SUMMARY OF THE INVENTION

In accordance with a first aspect of the present invention there is disclosed a process for production of a concrete building element comprising the steps of: a) mixing a portion of glass cullet with one or more materials selected from a first group of materials consisting of concrete sand, stone aggregate and blast furnace slag to form a first admixture; b) mixing a portion of Portland cement with one or more materials selected from a second group of materials consisting of silica fume, silica sand and silica flour to form a second admixture; c) mixing the first admixture with the second admixture and a controlled amount of water to form a final concrete mixture; d)transferring the final concrete mixture into a molding means to form a preform having the desired shape of said building element; e) compacting the preform within the molding means; f) curing the preform without the addition of heat or steam for a first curing period; g) in an autoclave, following step f), further curing the preform in said one or more molds at temperatures ranging from 250 to 365° F. and at pressures ranging from 100 to 150 p.s.i. for a second curing period. The first curing period may be from 0.5 hours to 2.0 hours and the second curing period may be at least 8 hours.

According to another aspect of the invention, the process may involve having step g) comprise the sub-steps of: g)i) introducing steam into the autoclave in a controlled manner so as to raise the temperature and pressure within the autoclave gradually over the first half of the second curing period so as to attain said target values of 250 to 366° F. and 100 to 150 p.s.i., respectively, by the commencement of the second half of the second curing period; and, g)ii) once said target values of 250 to 366° F. and 100 to 150 p.s.i. are reached, holding the preform in said one or more mold at said temperature and pressure for the balance of the second curing period.

According to another aspect of the invention, the moulding means is a concrete block machine and the building element produced is a concrete building block.

According to yet another aspect of the invention, the weight of the glass cullet within the building element may be between about 1% to 50% of the weight of the building element, and preferably may be between about 5% to 50% of the weight of the building element.

According to still another aspect of the invention, the ratio of the combined weight of the first and second groups of materials to the weight of the Portland cement used therein may be between about 18.5:1.0 and 7.5:1.0, which favourable ratio reduces the amount of relatively expensive Portland cement, as compared with prior art cement compositions.

According to yet a further aspect of the invention, there is disclosed a concrete building element comprising a mixture of: a) Portland cement; b) glass cullet (as defined above); c) one or more materials selected from a first group of materials consisting of concrete sand, stone aggregate, and blast furnace slag; and, one or more materials selected from a second group of materials consisting of silica fume, silica sand and silica flour; wherein said mixture, after being mixed with water, is cured without the addition of heat or steam for a first curing period, and is thereafter cured in an autoclave at temperatures ranging from 250 to 366° F. and at pressures ranging from 100 to 150 p.s.i. for a second curing period.

It is an object of this invention to provide eco-friendly concrete building elements which utilize a significant amount of waste glass cullet as an integral component thereof, without the need for intensive pre-screening and selection of the waste glass component used therein.

It is a further object of this invention to provide eco-friendly concrete building elements which utilize a significant amount of waste glass cullet as an integral component thereof, without the need for finely grinding the waste glass component prior to its incorporation into the concrete mixture used to form the building elements.

It is another object of this invention to provide eco-friendly concrete building elements which utilize a significant amount of waste glass cullet as an integral component thereof, without the need for special additives to the concrete mixture to enhance chemical bonding of the silica from the glass with the other components of the concrete mixture thereby to mitigate against deterioration of the concrete building elements from ASR.

It is a further object of the present invention to significantly reduce the amount of limestone aggregate and concrete sand required to produce concrete mixtures having sufficient compressive strength to allow their use as structural building elements by utilizing waste glass, together with silica fume, silica sand, or silica flour in substitution for at least a portion of the stone aggregate and/or concrete sand fraction otherwise required in prior art concrete mixtures.

It is yet another object of the present invention to improve the compressive strength of concrete building elements having significant portions of glass cullet uniformly dispersed throughout the body of such building elements, and/or to otherwise obviate or mitigate against at least one of the above-mentioned disadvantages of the prior art.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

FIG. 1 is a photograph of a prior art concrete building element incorporating significant amounts of glass cullet which building element shows surface cracks caused by the ASR;

FIG. 2 is a photograph of a concrete building element produced in accordance with the present invention and incorporating significant amounts of glass cullet, which building element shows no significant surface cracks caused by the ASR;

### DETAILED DESCRIPTION OF A PREFERRED EMBODIMENT

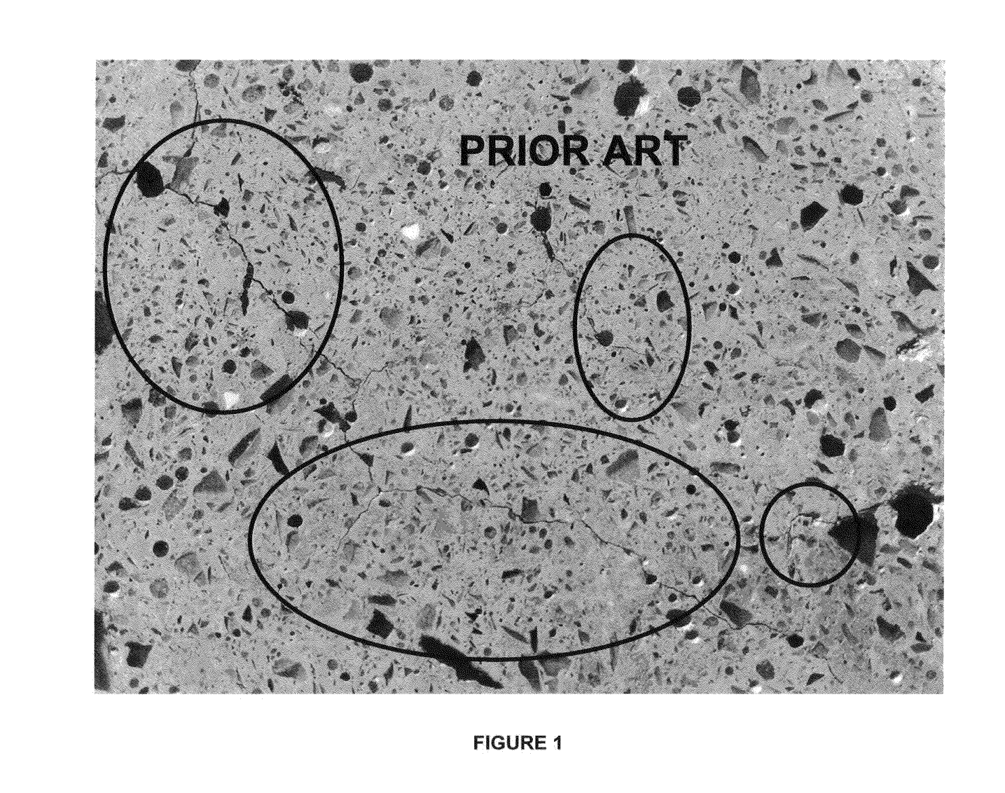

Referring to FIG. 1, there will be seen a close-up photograph showing the surface of a prior art concrete building element incorporating significant amounts of glass cullet (as defined above) to impart an appearance simulating natural quarried stone or terrazzo. The building element of FIG. 1 clearly shows visible surface cracks (some circled). This prior art building element was prepared by the inventor using a concrete mixture that included post-consumer waste glass cullet (approximately 30% by weight) dispersed through a matrix of Portland cement with concrete sand, and stone aggregate, made without the addition of silica sand, silica fume or silica flour, and without using the novel curing steps of the present invention. The building element shown in the photograph of FIG. 1 was exposed for several months to unprotected ambient atmospheric weather conditions (at Hamilton, Ontario, Canada) during which exposure the surface cracks visible in the photograph appeared. Such cracks are attributed by the inventor to ASR, and could reasonably be expected to increase in number and intensity over time, thereby making such a building element unsuitable for use as a structurally sound, low-cost alternative to natural quarried stone or terrazzo building elements.

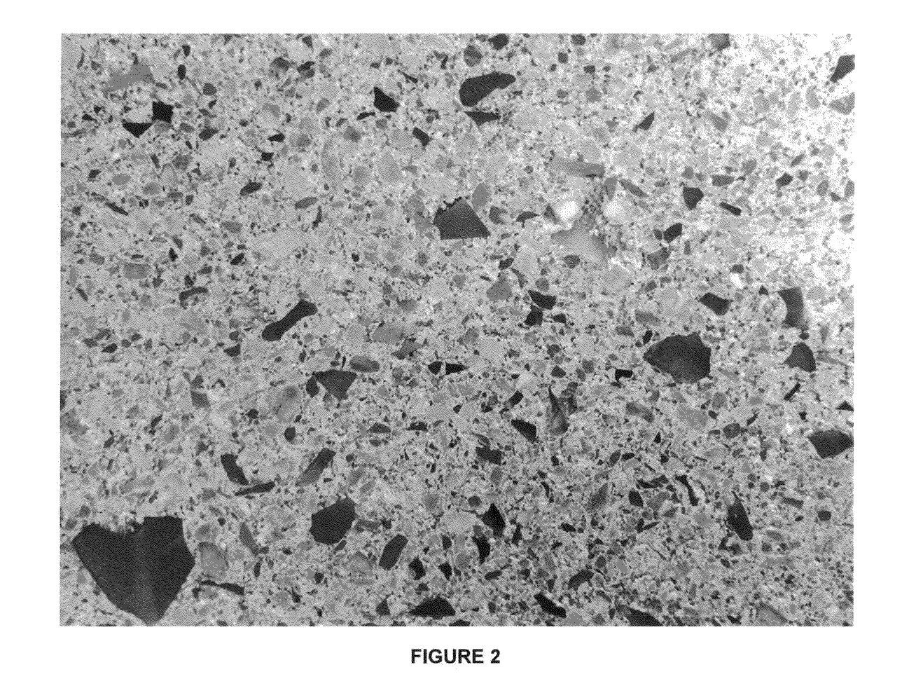

FIG. 2 shows a close-up photograph of the surface of a concrete building element having a similar composition to the concrete building element of FIG. 1, but prepared by the inventor using the novel process of the present invention. The building element shown in the photograph of FIG. 2 was also exposed to unprotected ambient atmospheric conditions (at Hamilton, Ontario, Canada) for a similar period of time as the building element of FIG. 1, after which time no surface cracks were visible in the building element, as can be seen from the photograph of FIG. 2. The paucity of such surface cracks is postulated by the inventor to be attributable to beneficial early binding of the silicates present in the glass particles with the alkalis present in the other components of the concrete mixture, which binding likely occurs during the curing steps of the novel manufacturing process disclosed and claimed herein, and is most likely accelerated to substantial completion during the second stage of the curing process, which second stage is carried out under elevated temperature and pressure, although the inventor in no way intends to be limited or bound by such theory. In any event, a concrete building element produced according to the present invention is resistant to degradation over time due to ASR, and provides an eco-friendly, relatively low-cost substitute for natural quarried stone or terrazzo building elements. Moreover, the product thus produced has a relatively high compressive strength, as compared to other concrete building elements which incorporate significant amounts of glass cullet, making it suitable not only to thin layer finishing applications, such as floor and wall tiles (to which applications prior art examples are generally limited), but also for structural applications, including pre-cast concrete building blocks, posts, beams, lintels and the like. Finally, such advantages are achieved without the prior art need for expensive reaction agents to cause early binding of the silicates derived from the glass component, and without the need to closely pre-select, or to finely mill the glass component incorporated therein.

The glass cullet used in the present invention may be derived from industrial waste glass streams (e.g., float and window glass), or from post-consumer waste glass streams, (e.g., recycled glass containers). A typical chemical composition for the glass cullet portion used herein is given in Table 1.

TABLE 1
Soda-lime glass composition (% by weight)

| | Typical container | Typical | Approximate |
|---|---|---|---|
| | glass | float glass | limits |
| SiO₂ | 74.42 | 71.86 | 63-81 |
| Al₂O₃ | 0.75 | 0.08 | 0-2 |
| MgO | 0.30 | 5.64 | 0-6 |
| CaO | 11.27 | 9.23 | 5-14 |
| Li₂O | 0.00 | 0.00 | 0-2 |
| Na₂O | 12.9 | 13.13 | 9-15 |
| K₂O | 0.19 | 0.02 | 0-1.5 |
| Fe₂O₃ | 0.01 | 0.04 | 0-0.6 |
| Cr₂O₃ | 0.00 | 0.00 | 0-0.2 |
| MnO₂ | 0.00 | 0.00 | 0-0.2 |
| Co₃O₄ | 0.00 | 0.00 | 0-0.1 |
| TiO₂ | 0.01 | 0.01 | 0-0.8 |
| SO₃ | 0.16 | 0.00 | 0-0.2 |
| Se | 0.00 | 0.00 | 0-0.1 |

In the case of post-consumer waste glass, it is important that the glass be cleaned and washed prior to use herein to ensure that paper, plastics, sugars and other known contaminants found in post-consumer glass and known to be detrimental to concrete mixtures have been substantially removed. The applicant has identified one or more reliable sources of glass cullet that is shipped pre-cleaned and washed by the supplier, such that they are otherwise suitable for use herein as received from the source, without the need for further pre-treatment prior to use herein. One such source is: Opta Minerals Inc., of Waterdown, Ontario, Canada. A recycled glass cullet mixture having a −½″ mesh particle size distribution (i.e., typically 90% or more of the particles will pass through a ½″ mesh sieve) is efficacious herein for making concrete blocks simulating the appearance of terrazzo or quarried natural stone, while a mixture having a −½″+12 mesh particle size distribution (i.e., typically 90% or more of the particles will pass through a ½″ mesh sieve and will be retained by a 12 mesh sieve) are particularly efficacious in this regard, although the claims herein are not to be so limited. The chemical analysis for this glass cullet (provided by Opta Minerals Inc.) is given in Table 2.

TABLE 2
Typical Chemical Analysis (Weight %):

| | | |
|---|---|---|
| Silicon Dioxide | SiO₂ | 74.00 |
| Sodium Oxide | Na₂O | 15.00 |
| Calcium Oxide | CaO | 5.00 |
| Aluminum Oxide | Al₂O₃ | 1.00 |
| Other | | 1.00 |

The physical property analysis of this product (as provided by Opta Minerals Inc.) is given in Table 3.

TABLE 3
Physical Properties:

| Colour | Multi | Grain Shape | Angular |
|---|---|---|---|
| Bulk Density (loose) | 78 lbs./ft.³ | Mohs Hardness | >6.0 |
| Bulk Density (compacted) | n/a lbs./ft.³ | Specific Gravity | ~2.6 |
| Moisture | <0.20% | Solubility | Insoluble |

Portland cement is an essential ingredient in modern concrete mixtures, and is produced by grinding Portland cement clinker (more than 90%), a limited amount of calcium sulphate (which controls the set time), and up to 5% minor constituents as allowed by various standards, including CSA A3001 and ASTM C150. A typical chemical analysis for Portland cement is given in Table 4.

TABLE 4

| Cement | Weight % |
|---|---|
| Calcium oxide, CaO | 61-67% |
| Silicon dioxide, SiO₂ | 19-23% |
| Aluminum oxide, Al₂O₃ | 2.5-6% |
| Ferric oxide, Fe₂O₃ | 0-6% |
| Sulfur Trioxide, SO₃ | 1.5-4.5% |

A suitable Portland cement for use in the present invention is Type GU (Type 10), available from St. Mary's Cement Co., Toronto, Ontario, Canada.

Various types of crushed clear stone aggregate for use in concrete applications are known to those skilled in the cement arts, and most of these are suitable for use in conjunction with the present invention. A 6.7 mm (¼″) clear limestone chip aggregate is particularly useful in relation to the production of structural building elements according to the invention, most notably concrete building blocks, although other grades of crushed aggregate are also useful for particular applications. Suitable crushed limestone aggregates for the intended purpose are available from Nelson Aggregate Co. of Burlington, Ontario, Canada. A cumulative size distribution chart for ¼″ (6.7 mm) clear limestone chip aggregate supplied by Nelson Aggregates Co. to the applicant follows as Table 5:

TABLE 5

| | | Mesh Size | | | | | | | |
|---|---|---|---|---|---|---|---|---|---|
| | | ½″ | ⅜″ | ¼″ | #4 | #8 | #16 | #30 | #200 |
| | | 13.2 | 9.5 mm | 6.7 mm | 4.75 mm | 2.36 mm | 1.18 m | 600 um | 75 um |
| Sample # | AIM | 100 | 95 to 100 | 70 to 100 | 30 to 75 | 10 to 30 | 5 to 15 | 0 to 10 | 0 to 6 |
| 1 | Typical | 100 | 100 | 93.9 | 65.1 | 14.5 | 9.9 | 9.1 | 5.4 |
| 2 | Mean % | 100 | 100 | 96.6 | 68.0 | 12.5 | 10.9 | 10.8 | 7.2 |
| 3 | Retained on | 100 | 100 | 94.5 | 61.5 | 15.6 | 11.2 | 10.3 | 6.9 |
| 4 | Individual | 100 | 100 | 97.0 | 73.8 | 19.1 | 12.5 | 11.6 | 7.6 |
| 5 | Sieves | 100 | 100 | 94.7 | 62.3 | 19.0 | 13.1 | 12.1 | 7.5 |
| 6 | | 100 | 100 | 92.5 | 58.2 | 13.4 | 10.7 | 10.4 | 6.7 |
| 7 | | 100 | 100 | 94.0 | 59.2 | 9.7 | 9.0 | 8.7 | 6.6 |
| 8 | | 100 | 100 | 96.7 | 75.2 | 20.7 | 14.3 | 12.6 | 7.8 |
| 9 | | 100 | 100 | 87.6 | 48.3 | 5.0 | 4.4 | 4.3 | 3.7 |
| 10 | | 100 | 100 | 88.9 | 55.4 | 10.1 | 7.2 | 6.8 | 5.3 |
| AVG. | | 100 | 100 | 93.6 | 62.7 | 14.0 | 10.3 | 9.7 | 6.5 |

Concrete sand suitable for use in the present invention is well known in the art and widely available from various aggregate suppliers. The choice of a concrete sand for any particular application will depend to a significant degree upon local availability and the desired surface texture of the building element being produced. One suitable concrete sand, having particles size distribution ranging from between about 0.0075 mm (0.0029″) to about 4.75 mm (0.187″), is available from Nelson Aggregates Co. (infra).

Other materials selectively used herein include: blast furnace slag, silica fume, silica sand, and silica flour, all of which are used herein to improve the properties of the concrete mixture (including its compressive strength, bond strength, and resistance to the ASR), and as a partial replacement for Portland cement.

Blast furnace slag is obtained by quenching molten iron slag (a by-product of iron and steel-making) from a blast furnace in water or steam, to produce a glassy, granular product that is then dried and ground into a fine powder. It is known to have latent hydraulic properties. While the chemical composition of blast slag can vary significantly depending upon its source, the main chemical components are CaO (30-50%), SiO₂ (28-38%), Al₂O₃ (8-24%), and MgO (1-18%).

Silica fume, also known as microsilica, (CAS number 69012-64-2, EINECS number 273-761-1) is an amorphous (non-crystalline) polymorph of silicon dioxide. It is an ultrafine powder collected as a by-product of silicon and ferrosilicon alloy production, and consists of spherical particles with an average particle diameter of 150 nm. Silica fume is particularly useful in improving the compressive strength, bond strength, and abrasion resistance of concrete mixtures.

Silica sand is produced from high purity quartz sands for a wide variety of industrial and contractor mixed applications, including cement mixtures, where a reliable silica contribution is required. It is readily available from various sources. A suitable silica sand for use in the present invention is available in several grades under the trademark GRANUSIL™ from Unimin Corporation of New Canaan, Conn., USA. The chemical analysis for GRANUSIL™ (as provided by Unimin Corporation) is given in Table 6.

TABLE 6
Mean Percentage by Weight

| | | |
|---|---|---|
| Silicon Dioxide | (Si0₂) | 99.47 |
| Iron Oxide | (Fe₂0₃) | 0.05 |
| Aluminum Oxide | (Al₂0₃) | 0.30 |
| Calcium Oxide | (CaO) | <0.01 |
| Magnesium Oxide | (MgO) | 0.05 |
| Potassium Oxide | (K₂0) | <0.01 |
| Sodium Oxide | (Na₂0) | 0.02 |
| Loss on Ignition | (L.O.I.) | 0.07 |

The particle size analysis for the GRANUSIL™ silica sand (as provided by Unimin Corporation) is given in Table 7.

TABLE 7

| | Mesh Size | | Grade | | |
|---|---|---|---|---|---|
| | ASTM E-11 | Microns | 2030W | 4030W | 4010W |
| Typical Mean % | 8 | 2.36 mm | — | — | — |
| Retained on | 16 | 1.18 mm | 3.0 | — | — |
| Individual Sieves | 20 | 850 | 12.0 | 2.0 | 0.2 |
| | 30 | 600 | 28.0 | 10.0 | 1.6 |
| | 40 | 425 | 31.0 | 25.0 | 8.5 |
| | 50 | 300 | 19.0 | 37.5 | 28.0 |
| | 70 | 212 | 5.0 | 19.0 | 33.0 |
| | 100 | 150 | 1.5 | 5.0 | 21.5 |
| | 140 | 106 | 0.4 | 1.2 | 6.0 |
| | 200 | 75 | 0.1 | 0.2 | 1.0 |
| | 270 | 53 | tr | 0.1 | 0.2 |
| | PAN | PAN | — | — | Tr |

Other physical properties for the GRANUSIL™ silica sand (as provided by Unimin Corporation) are set out in Table 8.

TABLE 8

| | Sub- | |
|---|---|---|
| Grain Shape | angular | Visual |
| Hardness | 7.0 | Moh's Scale |
| Moisture Content (%) | <10.0 | ASTM C-566 |
| Specific Gravity (g/cm3) | 2.65 | ASTM C-128 |
| Bulk Density, loose (lb/ft3) | 84.5 | ASTM C-29 |
| Bulk Density, compacted (lb/ft3) | 90 | ASTM C-29 |

Silica flour is made by milling pure silica sand to a very fine powder. A suitable silica flour for use in the present invention is available in two grades from Opta Minerals Inc., (infra). The chemical analysis for silica flour is essentially the same as for the silica sand from which it is produced, and Opta Minerals Inc. has provided chemical analysis for its silica flour as set out in Table 9.

TABLE 9
Mean Percentage by Weight

| | | |
|---|---|---|
| Silicon Dioxide | (Si0₂) | 99.7 |
| Iron Oxide | (Fe₂0₃) | 0.016 |
| Aluminum Oxide | (Al₂0₃) | 0.14 |
| Calcium Oxide | (CaO) | <0.01 |
| Magnesium Oxide | (MgO) | <0.01 |
| Potassium Oxide | (K₂0) | <0.04 |
| Sodium Oxide | (Na₂0) | <0.01 |

The particle size analysis for the two silica flour grades sourced from Opta Minerals Inc. (as provided by Opta Minerals Inc.) is given in Table 10.

TABLE 10

| | |
|---|---|
| Mesh Size | Grade |

| | ASTM E-11 | Microns | #125 | #290 |
|---|---|---|---|---|
| Typical Mean % | 16 | 1.18 mm | — | — |
| Retained on | 20 | 850 | — | — |
| Individual Sieves | 30 | 600 | — | — |
| | 40 | 425 | — | — |
| | 50 | 300 | — | — |
| | 70 | 212 | — | — |
| | 100 | 150 | — | — |
| | 140 | 106 | 1 | 1 |
| | 200 | 75 | 4 | 4 |
| | 270 | 53 | 11 | 11 |
| | 325 | 45 | 6 | 7 |
| | PAN | PAN | 78 | 77 |

Other physical properties for the Opta Minerals Inc. silica flour (as provided by Opta Minerals Inc.) are set out in Table 11.

TABLE 11

| Grain Shape | Sub-angular | Visual |
|---|---|---|
| Hardness | 7.0 | Moh's Scale |
| Specific Gravity (g/cm3) | 2.65 | ASTM C-128 |
| Bulk Density, aerated (lb/ft3) | 99 | ASTM C-29 |

Another silica flour particularly suited for use in the present invention is available under the trademark GRANUSIL™ grade 8000 from Unimin Canada Ltd. of St. Canut, Quebec, CANADA. The particle size distribution, chemical analysis and other physical properties for GRANUSIL™ 8000(as provided by Unimin Corporation) are given in Tables 12, 13 and 14, respectively.

TABLE 12
Mesh Size

| STM | Microns | 8000 | |
|---|---|---|---|
| 20 | 850 | — | Typical Mean % |
| 30 | 600 | — | Retained on |
| 40 | 425 | 0.2 | Individual Sieves |
| 50 | 300 | 1.0 | |
| 70 | 212 | 6.2 | |
| 100 | 150 | 7.4 | |
| 140 | 106 | 14.2 | |
| 200 | 75 | 16.0 | |
| 270 | 53 | 10.3 | |
| 325 | 45 | 2.0 | |
| PAN | PAN | 42.7 | |

TABLE 13
Mean Percent by Weight

| | | |
|---|---|---|
| Iron Oxide | (Fe₂O₃) | 0.25 |
| Aluminum Oxide | (Al₂O₃) | 1.55 |
| Calcium Oxide | (CaO) | 0.83 |
| Titanium Dioxide | (TiO₂) | 0.01 |
| Magnesium Oxide | (MgO) | 0.03 |
| Potassium Oxide | (K₂O) | 0.06 |
| Sodium Oxide | (Na₂O) | 0.01 |
| Loss on Ignition | (L.O.I.) | 0.21 |

TABLE 14

| Grain Shape | Subround | Visual |
|---|---|---|
| Hardness (Mohs) | 7.0 | Moh's Scale |
| Moisture Content (%) | <0.1 | ASTM C-566 |
| Specific Gravity (q/cm³) | 2.65 | ASTM C-128 |
| Bulk Density, loose (lb/ft³) | 92-95 | ASTM C-29 |
| Bulk Density, compacted (lb/ft³) | 98-100 | ASTM C-29 |

The process of the present invention is suited for manufacturing concrete building elements, such as, for example, pre-cast concrete blocks, posts, beams and lintels and is ideally carried out at a central mix concrete batch plant. The process as described hereinbelow will be limited, for the sake of brevity, to the production of concrete blocks, (sometimes also referred to as “cement blocks” or “concrete masonry units”, abbreviated “CMU”), although it will be appreciated by those skilled in the art that the process can be applied with routine modifications to the production of other concrete pre-cast building elements, all of which form a part of the inventive subject matter herein.

The shapes and sizes of concrete blocks have been substantially standardized to ensure uniform building construction. The most common block size in the United States is referred to as an 8-by-8-by-16 block, with the nominal measurements of 8 in (20.3 cm) high by 8 in (20.3 cm) deep by 16 in (40.6 cm) wide. This nominal measurement includes room for a bead of mortar, and the block itself actually measures 7.63 in (19.4 cm) high by 7.63 in (19.4 cm) deep by 15.63 in (38.8 cm) wide. The most common block size in Canada has measurements of 190 cm high by 190 cm deep by 390.0 cm wide.

In a typical concrete batch plant producing concrete blocks, the concrete sand, stone aggregate and blast furnace slag are stored outside in large piles, and are transferred into storage bins in the plant by a conveyor belt as they are needed. The Portland cement and other additives are typically stored in large vertical silos to protect them from moisture. As a production run begins, the required amounts of sand, gravel, cement and other materials are transferred by gravity, by conveyer belts, or by other mechanical means, to a weight batching scale on the measuring floor of the facility, which weight batching scale measures the proper amounts of each material. The dry materials then flow into a batch mixer, where they are blended together. After the dry materials are blended, water is added to the mixer. If the plant is located in a climate subject to temperature extremes, the water may first pass through a heater or chiller to regulate its temperature. Other additives, such as pigments, blast furnace slag, fillers, etc., may also be added to the mixer at this stage.

The final concrete mixture is then mixed thoroughly and the desired final water content is adjusted. Once the load of concrete is thoroughly mixed to the desired consistency, it is dumped from the mixer into an inclined bucket conveyor, or other mechanical transport means, for transport to an elevated hopper for subsequent processing. The mixing cycle begins anew for the next batch.

According to the present invention, a process for the production of a concrete block comprises the following steps, which need not be carried out in any particular order, unless expressly stated otherwise in this specification or the appended claims, or, unless successful attainment of the desired utility would require that a particular order of step(s) be necessary, as understood by an average person skilled in the concrete arts.

### Mixing

Glass cullet (as defined and described above) is received at the production facility for outside storage in a clean hopper. When required, it is sent from that hopper to another hopper through a series of conveyor belts. The second hopper is located on the top floor of the batch plant. The glass cullet is then fed into the batching scale located on the mixing room floor below for weighing out a portion of the glass cullet to be used in the concrete mixture. The scale collects the desired portion of the glass cullet for the mixture being produced (according to the mix design), and discharges same into the mixer.

Depending upon the selected mix design, one or more materials selected from a first group of materials consisting of concrete sand (as described above), stone aggregate (as described above), and blast furnace slag (as described above), are each fed in seriatum, in the same general manner as with the glass cullet, from their respective storage locations into the batching scale for weighing out the desired portion of each material for use in the mixture in preparation. The batching scale collects the desired portion of each material for the batch being produced (according to the mix design), and discharges each such portion into the mixer. These selected materials are preferably dry blended at this point with the glass cullet portion in the mixer to form a first admixture, with a 15 second dry mixing time being sufficient, but non-limiting, for this purpose.

At this point, approximately 50% of the controlled amount of water to be added to the concrete mixture may be preferably added to the first admixture in the mixer and mixed therewith to form a pre-wet mixture. The other 50% is added later, as discussed below. Moisture probes incorporated into the mixer automatically monitor the moisture content of the concrete mixture on a continuous basis, as is well known in the art.

The controlled amount of water to be added to the novel concrete mixture disclosed and claimed herein can vary significantly depending upon the moisture content of the starting materials. This is particularly the case with stone aggregate and concrete sand that have been stored outside and exposed to rain. For example, in a typical concrete batch mixture according to the invention and having a total batch weight of approximately 5,000 lbs., where the stone aggregate, concrete sand and/or blast furnace slag originate in a dry state, the batch would require a controlled amount of water of between about 100 L (220 lbs.) to 140 L (308 lbs.) to be added in two stages (as described herein) during its preparation. In contrast, where the stone aggregate, concrete sand and/or blast furnace slag originate in a moist state, the controlled amount of water to be added in two stages (as described herein) to the mixture could be reduced to between about 50 L (110 lbs.) to about 75 L (165 lbs.). For lightweight aggregates in a dry originating state, an acceptable controlled amount of water to be added to the concrete mixture could be between about 200 L (441 lbs.) to about 265 L (584 lbs.). If the lightweight aggregates originate in a moist state, this controlled amount of water can be reduced even further to between about 0 L (0.0 lbs.) to 110 L (242 lbs.), as lightweight aggregate is very porous and holds a significant amount of rain water.

The Portland cement is then mechanically fed from its storage silo into the batching scale located on the mixing room floor for weighing out a portion thereof to be used in the concrete mixture. The exact weight of the Portland cement will, of course, vary depending upon the selected mix design, examples of which are given hereinbelow.

Silica flour (as described above) is the preferred material to be selected from a second group of materials consisting of silica sand, silica fume and silica flour, for use in combination with the Portland cement portion, not only for reducing the amount of Portland cement otherwise required in the concrete mixture, but for maximizing resistance to the deleterious effects of ASR, whilst retaining relatively high compressive strengths. Notwithstanding this, various amounts of one or both of silica fume and silica sand (as both are described above) can also be advantageously used according to the present invention in place of, or in addition to, silica flour to obtain improved results over prior art concrete mixtures having significant percentages of glass cullet (as defined above). The choice of which material of this second group of materials to use, and the amounts of each, will depend to a significant extent on factors such as, for example: the availability of silica flour as compared to silica fume and silica sand; the cost of silica flour as compared to silica fume and silica sand; and the percentage by weight of glass cullet to be used in the final mix design, with more silica flour being recommended with higher glass percentages. The final mix design will take into consideration all of these factors and the specific application for the concrete building element being produced. While the strength of the high pressure steam cured concrete building elements produced according to the present invention is influenced by the amount and size of the siliceous materials used in the mix design, this is so to a much lesser degree where lean, dry concrete mixtures are utilized than where rich, wet concrete mixtures are utilized.

Once a decision has been made on the final mix design to be employed with a particular batch of product, one or more materials are selected from the second group of materials consisting of silica fume, silica sand and silica flour, which selected materials may each be weighed on the batching scale and may be mixed together thereon with the Portland cement portion already on the scale to form a second admixture. This second admixture is discharged from the batching scale into the mixer for further mixing with the other materials already there, and for the addition of the remainder of the controlled amount of water called for by the mix design. This is termed the final wet. The final wet will take the moisture percentage to its target value. Once this value is attained, the mixer will go into a final mixing cycle for approximately 70 seconds to produce the final concrete mixture. The final concrete mixtures used for CMU production typically have a higher percentage of concrete sand, smaller stone aggregate particle distributions, and lower percentage of water than the concrete mixtures used for general construction purposes. This produces a relatively dense, dry, and stiff concrete mixture that holds it shape better as a preform when removed from the molds of the block machine. At this point, the final concrete mixture is ready for molding into concrete blocks (or other building elements) and it is dumped from the mixer onto an inclined bucket conveyor, or a similar transport means, and transferred to an elevated hopper so that the mixing cycle can begin again for the next batch.

### Molding

From the elevated hopper, the final concrete mixture is transferred into another hopper mounted on top of the block machine (or other molding means being used to form the desired concrete building elements being produced) at a measured flow rate. The block machine may be any conventional block machine that has a robust vibrational compaction feature, such as for example, a Besser V3-R or Besser V3-12 model block machine available from Besser Company, Alpena, Mich., USA.

Once in the block machine, the final concrete mixture is forced downward into molds within the machine. The molds consist of an outer mold box containing several mold liners. The liners determine the outer shape of the block and the inner shape of the block cavities, if any. Most block machines produce a plurality of block preforms simultaneously. The exact number of preforms produced per molding cycle will depend on the particular model of block machine utilized.

When the molds are filled with the final concrete mixture, the concrete preforms being formed within the molds are compacted by the weight of the upper mold head coming down on the mold cavities. This compaction may be supplemented by air or hydraulic pressure cylinders acting on the mold head. The block machines utilized herein also at this time preferably apply a burst of mechanical vibration on the filled moulds significant enough to not only aid in distribution of the final concrete mixture throughout the molds, but to enhance compaction of the final mixture within the molds.

Once the concrete block preforms have been compacted as aforesaid, they are pushed down and out of the molds of the concrete block machine onto a flat steel pallet. Typically, but not essentially, each preform will be placed on its own steel pallet to facilitate subsequent individual handling of the preform. The pallet and preform are then pushed clear of the block machine and onto a chain conveyor or the like. The preform may optionally pass under a rotating brush which removes loose material from the top of the preform.

The pallets of preforms are then conveyed to an automated stacker or loader which slides the pallets and the preforms supported thereon in stacked, horizontal and vertical spaced relation into a movable curing rack. From the time the preforms are pushed from the block machine until they are fully cured, it is desirable that the preforms do not touch one another (or other objects) as they are relatively soft and easily deformed. To this end, during this entire period, the bases of the preforms are preferably supported from below by the their respective steel pallet, which steel pallet also assists in keeping the adjacent preforms spaced from one another on conveyors and the like and provide a convenient way of lifting and otherwise handling the preforms without physically touching them.

### Curing

### First Curing Period

Each movable curing rack filled with preforms is then moved from the vicinity of the block machine to an enclosed area or room of sufficient size to hold a batch load of preforms at a time. This area or room should at normal room temperature (i.e., about 65° F.-75° F., and be substantially free of significant temperature fluctuations. This area may optionally be the pressure vessel of the autoclave discussed in the next paragraph, if this vessel has cooled to ambient temperature and pressure, and assuming it is otherwise available. In this latter case the door of the autoclave's pressure vessel should preferably be kept closed, but without activation of the steam boiler operatively connected thereto. The preforms are held in the curing racks in this room/area/pressure vessel for a first curing period of between about 0.5-2.0 to allow them to harden slightly. This time period will vary depending on the ambient temperature of the space in which the first curing step takes place. In the winter months of northern climates such as occur around the Great Lakes area of North America, this period would typically be between about 1-2 hours. In the summer months in this same area this first curing period could be reduced to 0.5-1.0 hour.

### Second Curing Period

Once the first curing period has elapsed, the curing racks holding the stacked preforms, if not already positioned in the pressure vessel of the autoclave, are moved therein for commencement of a curing second curing step under high pressure steam. Any autoclave designed for concrete block production, such as, for example, those used for the production of autoclaved aerated concrete, will be suitable for use herein, so long as it can produce and sustain the specified temperature and pressure parameters throughout this second curing step, which will last for a total period of approximately 8 to 10 hours. The inventor has found successful utility using an autoclave comprised of a Sparling™ pressure vessel, available through Graver Tank & Mfg. Co., Inc., of Pasadena, Tex., U.S.A., fed by a 400 hp Cleaver-Brooks steam boiler, available form Cleaver-Brooks, Inc., of Thomasville, Ga., USA, which equipment is merely illustrative of a suitable autoclave equipment set-up.

During approximately the first half of the second curing period, which first half is about 4-5 hours in duration, “poor quality” or wet steam is slowly pushed into the autoclave in a controlled manner at a rate of approximately 8,000-10,000 lbs. per hour so as to avoid thermal shock to the preforms. In this regard, during this first half of the second curing period, the autoclave should be operated (or programmed to operate) so as to slowly bring the operating temperature and steam pressure in the autoclave's pressure vessel up to a target operating temperature of between about 250° F. to 366° F. and a target operating pressure of between about 100 p.s.i.-150 p.s.i. by the end of the first half of the second curing period.

In this manner, the autoclave will have reached its intended operating temperature by the second half of the second curing period, at which temperature and pressure it should be held for the second half of the second curing period, lasting between about a further 4-5 hours.

After the second curing period has been completed, (i.e., approximately 8-10 hours after it started), the steam is discharged from the pressure vessel of the autoclave through a large tailgate valve. It typically takes 20-30 minutes to exhaust the wet steam from the autoclave sufficiently to safely allow the door of the autoclave's pressure vessel to be opened.

Once sufficiently cooled, the racks of cured concrete blocks may be rolled out of autoclave, and the steel pallets carrying the blocks are removed from the curing racks. The cured blocks are then removed from the steel pallets on which they have heretofore been supported and the empty steel pallets are fed back into the block machine to receive a new set of moulded preforms. The cured concrete blocks with then pass through a mechanical cuber, which machine aligns and stacks arrays of the cured blocks onto wooden pallets. These pallets of blocks cubes are inventoried and carried to storage with a forklift for subsequent shipment to customers. Alternatively one or more exterior faces of the cured building elements may be polished using conventional polishing equipment before they are inventoried, so as to improve the surface finish thereof for specific decorative applications.

The concrete building elements removed from the autoclave are over 99% cured, such that they are typically ready for use within 24 hours after molding. Moreover, the compressive strength of the high pressure steam cured CMU's produced by the process described above are, after 24 hours, is comparable to conventional CMU's (without glass cullet) produced by moist curing at low pressure (i.e., without an autoclave) after 28 days (see Tables 15 and 16 below). Most importantly, this high early strength is permanent, and the blocks thus produced are extremely resistant to the deleterious effects of ASR due to the extensive and strong bonding of the silica components of the glass cullet with the alkali components of the concrete mixture enhanced by the high pressure curing process disclosed and claimed herein.

### Mix Design

A master (overall) mix design according to the invention and suitable for concrete block production may comprise the following proportions of materials (for preparation of a 5,000 lbs. batch), further details of the listed materials having been given above:

| | | |
|---|---|---|
| Portland cement | 240-540 | lbs. |
| Glass cullet | 0-2100 | lbs. |
| Stone Aggregate | 0-2100 | lbs. |
| Blast furnace slag | 0-3800 | lbs. |
| Concrete Sand | 0-3200 | lbs. |
| Silica fume and/or silica | 150-275 | lbs. |
| sand, and/or silica flour | | |

It will be seen that the above mix designs have considerable flexibility in the amount of glass cullet that can be substituted for the stone aggregate and concrete sand components of the mixture. Thus, the percentage of waste glass cullet used can vary significantly depending upon, for example, architect specifications for a particular building application.

The above ingredients are selected and mixed according to the steps previously disclosed, during which mixing a controlled amount of water between about 0.0 L (0.0 lbs.) to 265 L (584 lbs.), as detailed above, is also added to the mixture in stages. From this master design mix, it will be appreciated that the limestone aggregate can be supplemented in part with glass cullet, or be completely replaced by glass cullet of the same or a similar size. Similarly, the concrete sand can be supplemented, in whole or in part, by a glass cullet having a similar particle distribution as the replaced sand.

These and other aspects of the invention will be more fully understood by reference to the following examples of mix designs, which mix designs are to be considered as merely illustrative of the range of mix designs having utility according to the invention.

### Example 1

### 5% Glass Cullet Concrete Mixture

A concrete block having the following mix design, together with a controlled amount of water, was produced according to the above-described process:

| | |
|---|---|
| Glass Cullet (12 mesh) | 230 lbs. |
| Concrete Sand | 2900 lbs. |
| ¼″ limestone chip aggregate | 1470 lbs. |
| Portland Cement | 250 lbs. |
| Silica Flour | 140 lbs. |

### Example 2

### 10% Glass Cullet Concrete Mixture

A concrete block having the following mix design, together with a controlled amount of water, was produced according to the above-described process:

| | |
|---|---|
| Glass Cullet (12 mesh) | 499 lbs. |
| Concrete Sand | 2900 lbs. |
| ¼″ limestone chip aggregate | 1200 lbs. |
| Portland Cement | 250 lbs. |
| Silica Flour | 140 lbs. |

### Example 3

### 15% Glass Cullet Concrete Mixture

A concrete block having the following mix design, together with a controlled amount of water, was produced according to the above-described process:

| | |
|---|---|
| Glass Cullet (12 mesh) | 749 lbs. |
| Concrete Sand | 2900 lbs. |
| ¼″ limestone chip aggregate | 951 lbs. |
| Portland Cement | 250 lbs. |
| Silica Flour | 140 lbs. |

### Example 4

### 20% Glass Cullet Concrete Mixture

A concrete block having the following mix design, together with a controlled amount of water, was produced according to the above-described process:

| | |
|---|---|
| Glass Cullet (12 Mesh) | 1000 lbs. |
| Concrete Sand | 2900 lbs. |
| ¼″ limestone chip aggregate | 700 lbs. |
| Portland Cement | 260 lbs. |
| Silica Flour | 140 lbs. |

### Example 5

### 25% Glass Cullet Concrete Mixture

A concrete block having the following mix design, together with a controlled amount of water, was produced according to the above-described process:

| | |
|---|---|
| Glass Cullet (12 mesh) | 1150 lbs. |
| Concrete Sand | 2750 lbs. |
| ¼″ limestone chip aggregate | 700 lbs. |
| Portland Cement | 260 lbs. |
| Silica Flour | 140 lbs. |

### Example 6

### 30% Glass Cullet Concrete Mixture

A concrete block having the following mix design, together with a controlled amount of water, was produced according to the above-described process:

| | |
|---|---|
| Glass Cullet (12 mesh) | 1500 lbs. |
| Concrete Sand | 2000 lbs. |
| ¼″ limestone chip aggregate | 1100 lbs. |
| Portland Cement | 260 lbs. |
| Silica Flour | 140 lbs. |

Compressive strength tests were carried out using test method ASTM-C140 on eight concrete blocks produced according to the above 30% glass cullet concrete mixture mix design, with the results of this test being shown in Table 15.

TABLE 15

| | MASS AS | DIMENSIONS | AREA | | | COMPRESSIVE | | | | | | MOISTURE |
|---|---|---|---|---|---|---|---|---|---|---|---|---|
| UNIT | RECEIVED | L × W × H | GROSS | NET | | GROSS | NET | DENSITY | PERCENT | ABSORBTION | | CONTENT |
| NO. | (kg) | (mm) | (mm²) | (mm²) | LOAD IN | (MPa) | (MPa) | (KG/M3) | SOLID | (%) | (kg/m³) | (%) |
| A | 16.016 | 390 × 190 × 190 | 74100 | 40832 | — | — | — | 2 053 | 55.1 | 6.7 | 137 | 0.5 |
| B | 16.233 | 390 × 190 × 190 | 74100 | 40905 | — | — | — | 2 083 | 55.2 | 6.2 | 129 | 0.3 |
| C | 16.159 | 390 × 190 × 190 | 74100 | 41026 | — | — | — | 2 263 | 55.4 | 6.6 | 137 | 0.5 |
| D | 16.322 | 390 × 190 × 190 | 74100 | 40921* | 1156538 | 15.6 | 28.3 | — | — | — | — | — |
| E | 16.213 | 390 × 190 × 190 | 74100 | 40921* | 1096487 | 14.8 | 26.9 | — | — | — | — | — |
| F | 16.283 | 390 × 190 × 190 | 74100 | 40921* | 1069797 | 14.4 | 26.2 | — | — | — | — | — |
| G | 16.265 | 390 × 190 × 190 | 74100 | 40921* | 1016419 | 13.7 | 24.9 | — | — | — | — | — |
| H | 16.264 | 390 × 190 × 190 | 74100 | 40921* | 1083142 | 14.6 | 26.5 | — | — | — | — | — |
| | | | | | Average | 14.6 | 26.6 | 2 066 | 55.2 | 6.5 | 134 | 0.4 |

### Example 7

### 42% Glass Cullet Concrete Mixture

A concrete block having the following mix design, together with a controlled amount of water, was produced according to the above-described process:

| | |
|---|---|
| Glass Cullet (12 mesh) | 2095 lbs. |
| Concrete Sand | 2095 lbs. |
| ¼″ limestone chip aggregate | 805 lbs. |
| Portland Cement | 260 lbs. |
| Silica Flour | 140 lbs. |

Compressive strength tests were carried out using test method ASTM-C140 on three concrete blocks produced according to the above 42% glass cullet concrete mixture mix design, with the results of this test being shown in Table 16.

TABLE 16

| | MASS AS | DIMENSIONS | AREA | | | COMPRESSIVE | | | | | | MOISTURE |
|---|---|---|---|---|---|---|---|---|---|---|---|---|
| UNIT | RECEIVED | L × W × H | GROSS | NET | | GROSS | NET | DENSITY | PERCENT | ABSORBTION | | CONTENT |
| NO. | [symbol] | [symbol] | [symbol] | [symbol] | LOAD IN | [symbol] | [symbol] | [symbol] | SOLID | (%) | (kg/m³) | [symbol] |
| A | 15.899 | 392 × 190 × 190 | 74780 | 40921* | 1036436 | 14.0 | 25.6 | — | — | — | — | — |
| B | 15.606 | 392 × 190 × 190 | 74480 | 40921* | 747301 | 10.1 | 18.5 | — | — | — | — | — |
| C | 15.441 | 392 × 190 × 190 | 74480 | 40921* | 778439 | 10.5 | 19.2 | — | — | — | — | — |
| | | | | | Average | 11.5 | 21.1 | | | | | |

[symbol]

indicates data missing or illegible when filed

Concrete building elements constructed according to the above examples gave a clear ring when tested with a hammer, had a surface appearance substantially similar to that shown in FIG. 2, and a compressive strength which makes them suitable for use as structural building elements. Moreover, such building elements are initially free from cracks and fissures, and demonstrate increased resistance over time to the deleterious effects of the ASR.

The various formulations, specifications, methods and examples given above are by way of example, only, and other modifications and alterations thereto will be readily apparent to those skilled in the concrete arts without departing from the spirit and scope of the invention, which is limited only by the appended claims.

I claim:

1. A process for production of a non-sheet form structural building element simulating terrazzo or quarried stone comprising the steps of:
a) mixing glass cullet having a particle size distribution of −½″+12 mesh in an amount of from 1% to 50% of the total weight of the non-sheet form structural building element with one or more materials selected from a first group of materials consisting of concrete sand, stone aggregate and blast furnace slag to form a first admixture;
b) mixing Portland cement with one or more materials selected from a second group of materials consisting of silica fume, silica sand and silica flour to form a second admixture;
c) mixing the first admixture with the second admixture and water to form a final mixture;
d) transferring the final mixture into a molding means to form a preform having the desired shape of said non-sheet form structural building element;
e) compacting the preform within the molding means;
f) curing said preform without the addition of heat or steam for a first curing period;
g) in an autoclave, following step f), further curing the preform in said one or more molds at temperatures ranging from 250 to 365° F. and at pressures ranging from 100 to 150 p.s.i. for a second curing period.

2. The process of claim 1, wherein half of the water is mixed with the first admixture after step a) and before step c).

3. The process of claim 2, wherein the first curing period is from 0.5 hours to 2.0 hours and the second curing period is at least 8 hours.

4. The process of claim 3, wherein step g) comprises the sub-steps of:
g)i) introducing steam into the autoclave in a controlled manner so as to raise the temperature and pressure within the autoclave gradually over the first half of the second curing period so as to attain said target values of 250 to 366° F. and 100 to 150 p.s.i., respectively, by the commencement of the second half of the second curing period; and,
g)ii) once said target values of 250 to 366° F. and 100 to 150 p.s.i. are reached, holding the preform at said temperature and pressure for the balance of the second curing period.

5. The process of claim 4, wherein the molding means is a concrete block machine and the non-sheet form building element produced is a concrete masonry unit (“CMU”).

6. The process of claim 5, wherein the weight of the glass cullet portion is 5% of the total weight of the non-sheet form structural building element.

7. The process of claim 5, wherein the weight of the glass cullet portion is 15% of the total weight of the non-sheet form structural building element.

8. The process of claim 5, wherein the weight of the glass cullet portion is 20% of the total weight of the non-sheet form structural building element.

9. The process of claim 5, wherein the weight of the glass cullet portion is 25% of the total weight of the non-sheet form structural building element.

10. The process of claim 5, wherein the weight of the glass cullet portion is 30% of the total weight of the non-sheet form structural building element.

11. The process of 5, wherein the weight of the glass cullet portion is 42% of the total weight of the non-sheet form structural building element.

12. The process of claim 1, wherein the ratio of the combined weight of the first and second groups of selected materials to the weight of the Portland cement is between 18.5:1.0 and 7.5:1.0.

13. The process of claim 1, wherein the selected material in step b) is silica sand.

14. The process of claim 1, wherein the selected material in step b) is silica fume.

15. The process of claim 1, wherein the selected material in step b) is silica flour.

16. The process of claim 1, wherein the selected materials in step b) are both silica fume and silica sand.

17. The process of claim 1, wherein the selected materials in step b) are both silica sand and silica flour.

18. The process of claim 1, wherein the portion of glass cullet has a particle size distribution of −½″ mesh.

19. The process of claim 1, further comprising the step of polishing one or more exterior faces of the non-sheet form structural building element subsequent to step g).

20. A non-sheet form structural building element simulating terrazzo or quarried stone produced by a process comprising the steps of:
a) mixing glass cullet having a particle size distribution of −½″+12 mesh in an amount of from 1% to 50% of the total weight of the non-sheet form structural building element with one or more materials selected from a first group of materials consisting of concrete sand, stone aggregate and blast furnace slag to form a first admixture;
b) mixing Portland cement with one or more materials selected from a second group of materials consisting of silica fume, silica sand and silica flour to form a second admixture;
c) mixing the first admixture with the second admixture and water to form a final mixture;
d) transferring the final mixture into a molding means to form a preform having the desired shape of said non-sheet form structural building element;
e) compacting the preform within the molding means;
f) curing said preform without the addition of heat or steam for a first curing period;
g) in an autoclave, following step f), further curing the preform in said one or more molds at temperatures ranging from 250 to 366° F. and at pressures ranging from 100 to 150 p.s.i. for a second curing period.

21. A non-sheet form structural building element according to claim 20, wherein the first curing period is from 0.5 hours to 2.0 hours.

22. A non-sheet form structural building element according to claim 21, wherein the second curing period is for at least 8 hours.

23. A non-sheet form structural building element according to claim 20, wherein steam is introduced into the autoclave in a controlled manner so as to raise the temperature and pressure within the autoclave gradually over the first half of the second curing period to attain said target values of 250 to 366° F. and 100 to 150 p.s.i., respectively, by the commencement of the second half of the second curing period; and, wherein said target values of 250 to 366° F. and 100 to 150 p.s.i. are held steady for the balance of the second curing period.

24. A non-sheet form structural building element according to claim 20, wherein the weight of the glass cullet is 5% of the total weight of the non-sheet form structural building element.

25. A non-sheet form structural building element according to claim 20, wherein the weight of the glass cullet is 15% of the non-sheet form structural building element.

26. A non-sheet form structural building element according to claim 20, wherein the weight of the glass cullet is 20% of the non-sheet form structural building element.

27. A non-sheet form structural building element according to claim 20, wherein the weight of the glass cullet is 25% of the non-sheet form structural building element.

28. A non-sheet form structural building element according to claim 20, wherein the weight of the glass cullet is 30% of the non-sheet form structural building element.

29. A non-sheet form structural building element according to claim 20, wherein the weight of the glass cullet is 42% of the non-sheet form structural building element.

30. A non-sheet form structural building element according to claim 20, wherein the ratio of the weight of the first and second group of selected materials to the weight of Portland cement is between 18.5:1.0 and 7.5:1.0.

31. A non-sheet form structural building element according to claim 20, wherein the glass cullet has a particle distribution of −½″ mesh.

32. A non-sheet form structural building element according to claim 20, wherein said non-sheet form structural building element is a concrete masonry unit (“CMU”).

33. A non-sheet form structural building element according to claim 20, wherein said non-sheet form structural building element is polished on one or more of its exterior faces.
